(19) United States
(12) Patent Application Publication
(10) Pub. No.: US 2016/0275301 A1
(43) Pub. Date: Sep. 22, 2016

(54) INFORMATION SHARING CONTROL

(71) Applicant: Dots Communication, Inc., San Jose, CA (US)

(72) Inventors: Dhiraj Marya, San Jose, CA (US); Chiakai Hsu, San Jose, CA (US); Raymond Neil Walsh, II, San Jose, CA (US)

(21) Appl. No.: 14/660,873

(22) Filed: Mar. 17, 2015

(51) Int. Cl. G06F 21/62

(52) U.S. Cl. CPC G06F 21/6218

(57) ABSTRACT

Disclosed is a system for controlling the information that is shared during electronic device communication. Devices communicate with a server and one another through a network. Requests for connections between users are received and connection records are created. Information is shared and communications are managed according to instructions specified by users.

### BACKGROUND

1. Field of Art

The disclosure generally relates to the field of electronic communication, and more particularly to systems, methods, and user interfaces for controlling the information that is shared during electronic communication.

2. Description of Art

Communicating using electronic devices such as mobile devices is well known. A problem with mobile device communication is that it requires sharing contact information and other personal information, either willingly or unwillingly, to establish communication between two parties. This shared information includes, for example, a telephone number or email address. Once such information is shared, it is very difficult for the sharer to control or terminate the receiving party's ability to communicate with the sharer through the shared information. Consequently, mobile device users are often bombarded with unwanted communication without recourse.

One possible solution to cutting off unwarranted communication is to terminate the account associated with the shared information. However, this extremely burdensome and time-consuming. Moreover, it is disruptive as those that the user wishes to maintain communications with must be informed of the change in contact details and those informed must affirmatively update that information. Another solution is to use blocking features such as call blocking or spam reporting. However, the effectiveness of these features is limited even if they are established. In addition, for example, an unwarranted caller can call from an unblocked line and an unwarranted e-mailer can email from an unblocked email address.

To avoid this problem and the unfavorable solutions, many mobile device users are hesitant to share their contact information, which in turn reduces the amount of actual communication to below that which may actually be desired by the user.

### BRIEF DESCRIPTION OF THE DRAWINGS

The disclosed embodiments have advantages and features that will be more readily apparent from the detailed description, the appended claims, and the accompanying figures (or drawings). A brief introduction of the figures is below.

FIG. 1A illustrates an example embodiment of an environment for information sharing control.

FIG. 1B is a block diagram illustrating components of an example machine able to read instructions from a machine-readable medium and execute them in a processor (or controller).

FIG. 2 is a block diagram of a controlled communication server according to one embodiment.

FIG. 3 shows various modules and components of an application (app) client in accordance with one embodiment.

FIG. 4 shows various modules and components of an appless client in accordance with one embodiment.

FIG. 5 illustrates an example process for initiating a connection using information sharing control.

FIG. 6 illustrates an example process for creating a communication channel between users of information sharing control.

FIG. 7 illustrates an example process for routing messages using information sharing control.

FIG. 8 illustrates an example process for delivering messages to users of information sharing control.

FIG. 9A shows an example user interface for controlling information that is shared during electronic communication, according to one embodiment.

FIG. 9B shows an example user interface for controlling information that is shared during electronic communication, according to one embodiment.

FIG. 10A shows an example user interface displaying different content groups, according to one embodiment.

FIG. 10B shows an example user interface displaying different content groups, according to one embodiment.

FIG. 10C shows an example user interface displaying different content groups, according to one embodiment.

FIG. 10D shows an example user interface for creating a new content group, according to one embodiment.

FIG. 11A shows an example user interface for viewing and accessing user content of other users, according to one embodiment.

FIG. 11B shows an example user interface for viewing and accessing user content of other users, according to one embodiment.

FIG. 12A shows an example user interface for messaging between connected users, according to one embodiment.

FIG. 12B shows an example user interface for messaging between connected users, according to one embodiment.

FIG. 13A illustrates an example user interface for initiating a connection between users, according to one embodiment.

FIG. 13B illustrates an example user interface for initiating a connection between users, according to one embodiment.

FIG. 13C illustrates an example user interface for initiating a connection between users, according to one embodiment.

FIG. 14 illustrates an example process for terminating a connection between users of information sharing control.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments is an information sharing control configuration. The information sharing control configuration can be implemented as a system, method and/or a computer program product (e.g., a computer readable storage medium that stores instructions executable by one or more processing units). The information sharing control configuration in one embodiment includes a server, a network, and one or more clients with associated users. The server is adapted to receive a request from a first user comprising a user identifier of the first user and content handling instructions corresponding to a second user. The server receives a connection message from a device of the second user. The server additionally transmits a confirmation message to the device of the second user comprising shared contact information of the first user and determines the identifier of the first user and the content handling instructions in response to receiving a communication message from the device of the second user. The server executes one or more of the content handling instructions. The users interact in the environment through clients, e.g., 130, 135. The clients 130, 135 comprise electronic devices having communication capability using the network 110 further described below.

### Example Environment

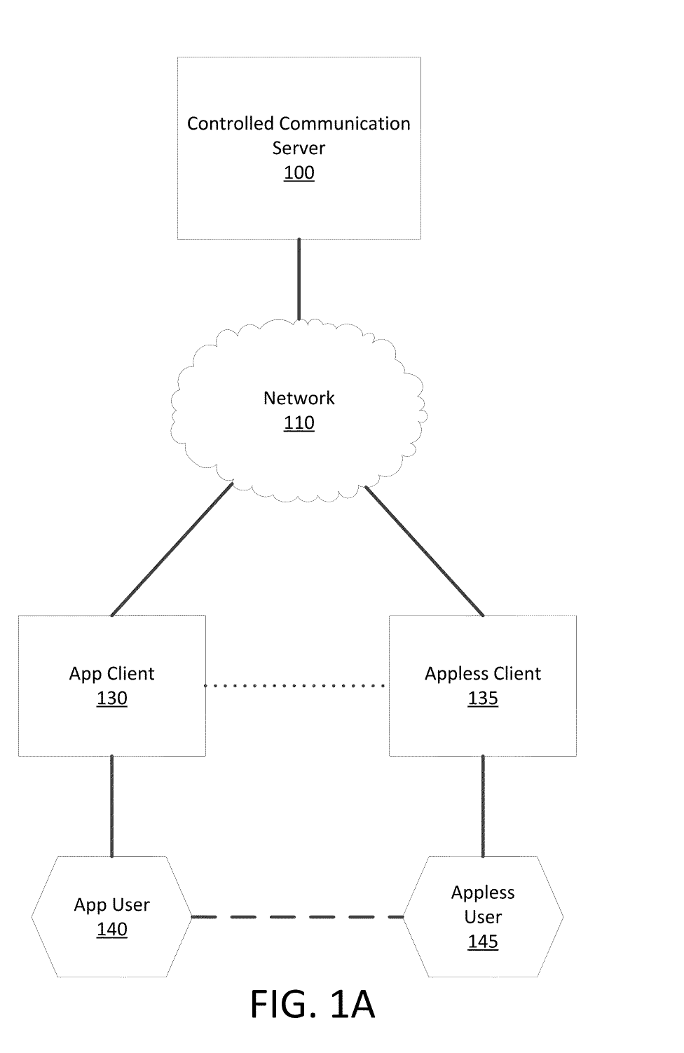

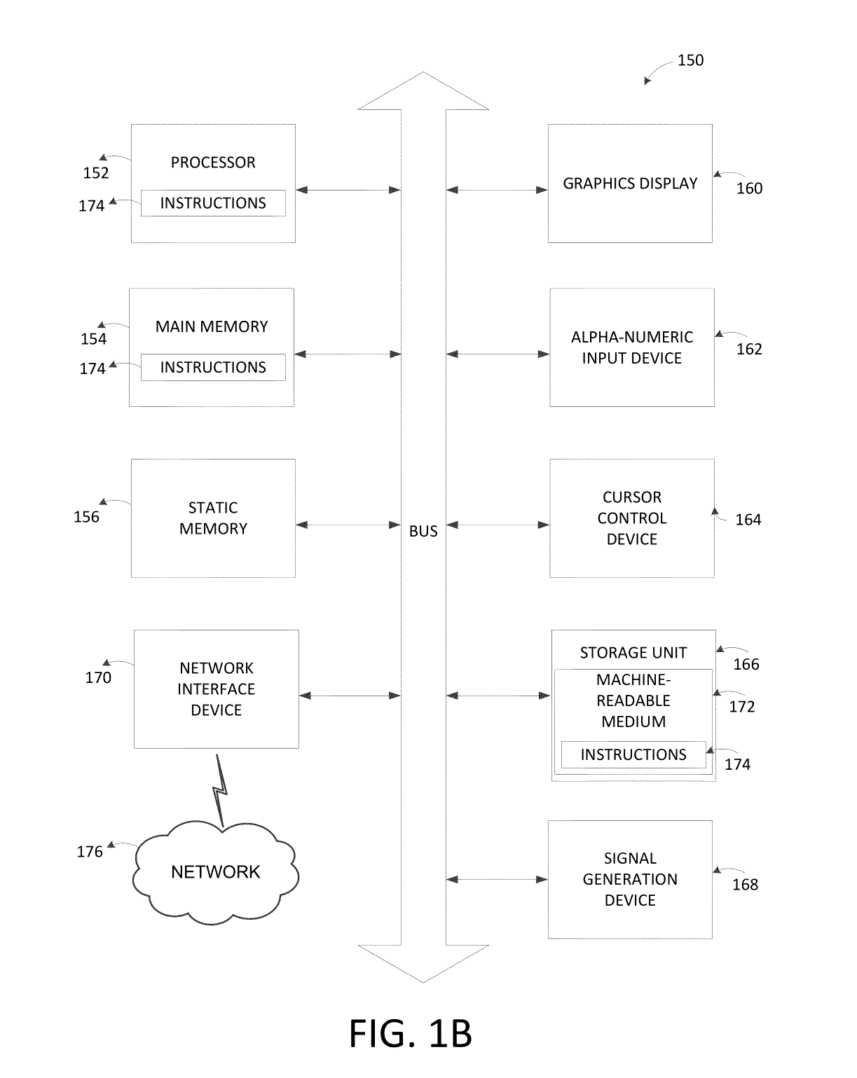

FIG. 1A illustrates an example embodiment of an environment for information sharing control. The environment includes controlled communication server 100, network 110, one or more application (app) clients 130 and one or more appless (i.e. does not have an app) clients 135, and one or more app users 140 and one or more appless users 145. In this example, app client 130 can be embodied as an application operating on a device configured for communication. The appless client 135 can be a device configured for communication. Note that although only two users 140 and 145 and two clients 130 and 135 are shown in FIG. 1A, this is only for purpose of illustration; in practice, any number of devices or users may be present in the environment. Similarly, other modules or components described and illustrated throughout may include single or multiple instances as appropriate to the needs of the implementer without loss of generality.

Controlled communication server 100 facilitates, via network 110, a controlled exchange of information between the users of information sharing control.

Network 110 is any suitable network and may include data and/or telecommunication networks (including mobile communication networks). In some configurations, clients 130, 135 communicate via a wired or wireless communication network to a local network service provider, and communicate with controlled communication server 100 through the Internet. In certain configurations, clients 130, 135 can communicate directly with one another without network 110 as indicated in FIG. 1A by a dotted line. For example, clients 130, 135 may communicate via a wired or wireless connection, such as wirelessly via a Bluetooth connection or a wired connection via a Universal Serial Bus (USB). In another embodiment, clients 130, 135 communicate via a cellular network.

A client 130, 135 may be an app client 130 or an appless client 135. In one embodiment, app client 130 has a software application that is used to facilitate communication with the controlled communication server 100. An appless client 135 does not have such a software application. In some configurations, clients 130, 135 communicate with the controlled communication server 100 using a client application on the client 130, 135 or SMS messaging.

In some configurations, appless client 135 communicates with controlled communication server 100 through a cellular network. Communication occurs through SMS messaging or a similar messaging protocol. Thus, appless client 135 need not even have the capability to run the software application to communicate with controlled communication server 100.

A user 140, 145 interacts with a client 130, 135 through one or more input devices, including a touch screen, physical buttons, a pointing device (e.g., touchpad, stylus, or mouse), and a keypad (e.g., keyboard). A user 140 may interact directly with another user 145 to share information for connecting using information sharing control.

### Example Machine Architecture

FIG. 1B is a block diagram illustrating components of an example machine able to read instructions from a machine-readable medium and execute them in a processor (or controller). Specifically, FIG. 1B shows a diagrammatic representation of a machine in the example form of a computer system 150. The computer system 150 can be used to execute instructions 174 (e.g., program code or software) for causing the machine to perform any one or more of the methodologies (or processes) described herein. In alternative embodiments, the machine operates as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 174 (sequential or otherwise) that specify actions to be taken by that machine. Further, while only a single machine is illustrated, the term “machine” shall also be taken to include any collection of machines that individually or jointly execute instructions 174 to perform any one or more of the methodologies discussed herein.

The example computer system 150 includes one or more processing units (generally processor 152). The processor 152 is, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The computer system 150 also includes a main memory 154. The computer system may include a storage unit 166. The processor 152, memory 154 and the storage unit 166 communicate via a bus 158.

In addition, the computer system 156 can include a static memory 156, a display driver 160 (e.g., to drive a plasma display panel (PDP), a liquid crystal display (LCD), or a projector). The computer system 150 may also include alphanumeric input device 162 (e.g., a keyboard), a cursor control device 164 (e.g., a mouse, a trackball, a joystick, a motion sensor, or other pointing instrument), an audio input device (e.g., a microphone), a signal generation device 168 (e.g., a speaker), and a network interface device 170, which also are configured to communicate via the bus 158.

The storage unit 166 includes a machine-readable medium 172 on which is stored instructions 174 (e.g., software) embodying any one or more of the methodologies or functions described herein. The instructions 174 may also reside, completely or at least partially, within the main memory 104 or within the processor 102 (e.g., within a processor's cache memory) during execution thereof by the computer system 150, the main memory 154 and the processor 152 also constituting machine-readable media. The instructions 174 may be transmitted or received over a network 176 via the network interface device 170.

While machine-readable medium 172 is shown in an example embodiment to be a single medium, the term “machine-readable medium” should be taken to include a single medium or multiple media (e.g., a centralized or distributed database, or associated caches and servers) able to store the instructions 174. The term “machine-readable medium” shall also be taken to include any medium that is capable of storing instructions 174 for execution by the machine and that cause the machine to perform any one or more of the methodologies disclosed herein. The term “machine-readable medium” includes, but not be limited to, data repositories in the form of solid-state memories, optical media, and magnetic media.

### Example Controlled Communication Server

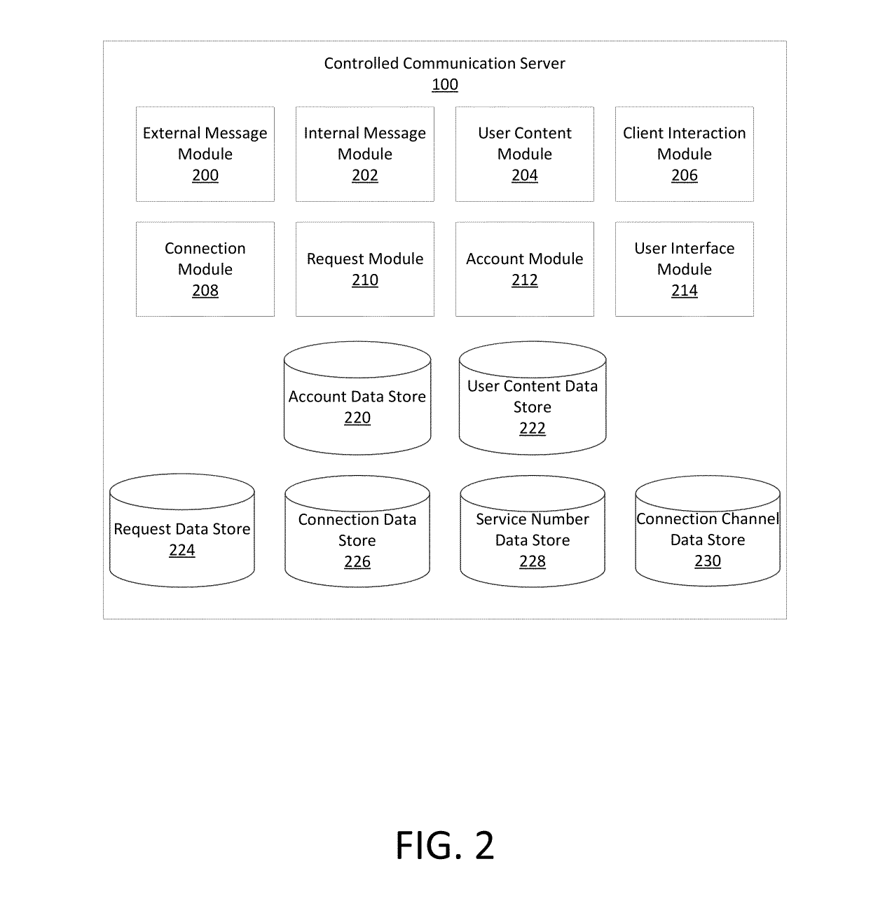

FIG. 2 is a block diagram of an example controlled communication server 100 according to one embodiment. In one embodiment, controlled communication server 100 includes external message module 200, internal message module 202, user content module 204, client interaction module 206, connection module 208, request module 210, account module 212, user interface module 214, account data store 220, user content data store 222, request data store 224, connection data store 226, service number data store 228, connection channel data store 230. In various embodiments, controlled communication server may additionally include various components of the example machine of FIG. 1B. It is noted that the modules described herein may be embodied as instructions stored in a storage device, e.g., 154, 166, and executable by a processor, e.g., 152, so that the processor, e.g., 152, is configured to perform the functions described.

Client interaction module 206 handles communications from clients 130, 135. In some embodiments, client communications may be received by external message module 200, internal message module 202, user interface module 214, or directly by client interaction module 206. In some embodiments, client interaction module 206 handles communications between clients 130, 135 and user content module 204, connection module 208, request module 210, and account module 212. Client interaction module 206 can be configured to interact with any number of other modules in controlled communication server 100.

In some embodiments, a user can access information sharing control via a web interface generated by user interface module 214. For example, the user can navigate in a web browser to a web address provided by controlled communication server 100.

User content module 204 receives and handles user content from users of information sharing control. User content includes contact information such as names, email addresses, phone numbers, physical addresses, web addresses. In one embodiment, user content is stored in user content data store 222. User content module 204 retrieves some or all of the user content from user data store 222 when a retrieval request is received. In some embodiments, a retrieval request may come from a client 130, 135 of an owner of the user content. Alternatively, the retrieval request may come from a client 130, 135 of a user authorized by the owner to view some or all of the user content.

When using information sharing control, to facilitate various functions, a user can create an account. The account information can be maintained in account data store 220, and is one means for performing this function. Account data store 220 can store profile information for registered users. Each user is associated with a unique user identifier, such as a userID, a user name, or a user number. A user's user identifier is assigned by account module 212. Available user identifiers are stored in account data store 220. Alternatively, account module 212 may generate new user identifiers based on previously assigned user identifiers.

In one embodiment, account data store 220 includes account management information, such as account type, e.g., free or paid; usage information for each user, e.g., security settings; personal configuration settings; etc. Account module 212 can be configured to update and/or obtain user account details in account data store 220. An account can be associated with multiple clients 130, 135. Account module 212 can be configured to interact with any number of other modules in controlled communication server 100. Account data store may include characteristics of clients 130,135. Characteristics include hardware model information, network capabilities, operating system information, messaging and notification capabilities and the like.

A user may request for the user's account to be connected to the account of another user. In some embodiments, request module 210 receives the connection request and stores it in request data store 224. A connection request includes content handling instructions. Content handling instructions include sharing instructions for which user content to share with the other user, as well as instructions for how the other user may communicate with the first user. Instructions may be stored in request data store 224 or in connection data store 226. Example instructions include instructions to share one or more user content items or data fields with a particular user, instructions to not share one or more user content items or data fields with a particular user, and instructions for how to handle communication from a particular user (i.e. instant messages, short message service (SMS), multimedia message service (MMS), phone calls, emails).

In some embodiments, request module 210 can also generate a connection request message to request authorization of the other user to connect accounts. The connection request message can be sent via SMS or other messaging protocol through external message module 200. Alternatively, the connection request message can be sent by internal message module 202. In some embodiments, external message module 200 uses a service number retrieved from service number data store 228 to send the connection request message. In this embodiment, the recipient of the connection request message is able to send a reply message to the service number to accept the connection request.

In various embodiments, if both users are app users, the users initiate a connection via the user interface of the client application, as described in more detail below. In some embodiments, a client application initiates a connection request by using character recognition to read an image containing personal information (e.g., a picture of a business card) or an indication or reference to personal information (e.g., a QR code or other symbolic representation). This method of initiating a connection is described in more detail below.

When a connection is made, connection module 208 creates a connection record in connection data store 226. The connection record includes the unique identifiers of the connected users as well as content sharing instructions for both users. The connection record may also include a connection channel retrieved from connection channel data store 230. A connection channel is an address, such as a phone number or SMS short code, that is associated with external message module 200. Each connection channel is only associated with one connection for each user. Accordingly when external message module 200 receives a message from a user through a particular connection channel, connection module 208 can determine the intended recipient from connection records.

User content can be stored in association with an account in account data store 220. The stored user content can also include content groups of various types with different behaviors, or other user content item grouping methods. Content groups are stored in account data store 220 or connection data store 226. For example, an account can include a public user content group that is accessible to any user. The public user content group can be assigned a web-accessible address. A link to the web-accessible address can be used to access the contents of the public content group. In another example, an account can include a private user content group that is accessible only to users authorized by the owner of the content. When a connection is made, the instructions for sharing content assign zero, one, or more content groups to the connected user, thus giving the connected user access to the content in each such content group.

External message module 200 is configured to receive messages from clients outside of the controlled system and send messages to clients outside of the system. External message module 200 uses network 110 to send and receive messages. Messages may be sent via a message service or other communication service (e.g., an SMS message service, a native device messaging system, etc.). Examples of a native device messaging system include iOS Push Notifications by APPLE, INC., Cupertino, Calif. and Android Notifications by GOOGLE INC., Mountain View, Calif. In various embodiments, internal message module 202 sends and receives messages within the information sharing control. Internal messages are sent when the message module of an app client has an active message-data connection with internal message module 202. An active message-data connection typically exists if the client application of the system is open and displayed on the app client.

### Example App Client

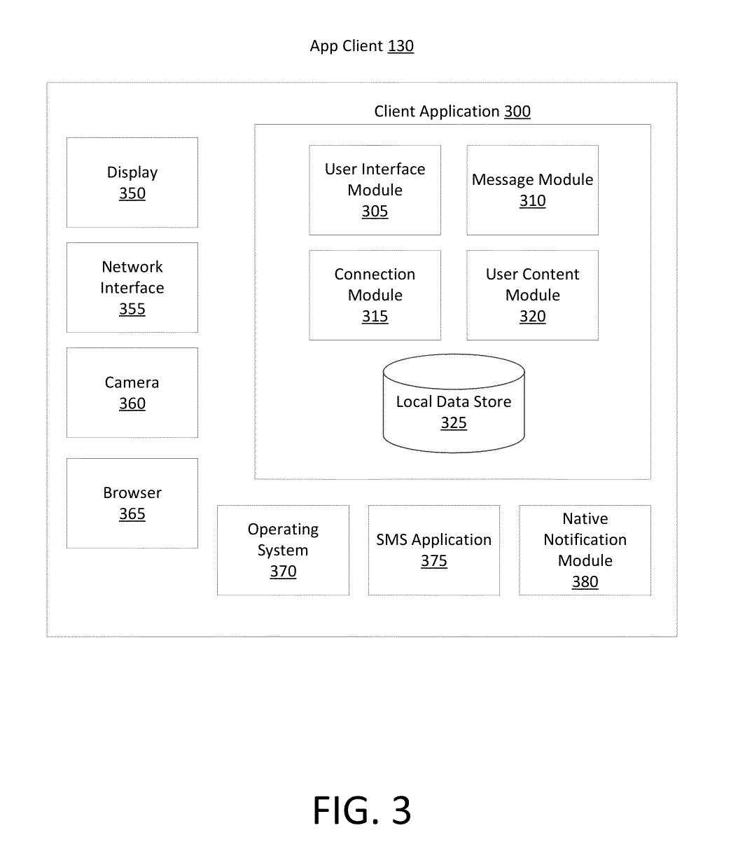

FIG. 3 is an example configuration of app client 130, according to one embodiment. App client 130 includes client application 300, display 350, network interface 355, camera 360, browser 365, operating system 370, and SMS application 375, and native notification module 380. In various embodiments, app client 130 may additionally include various components of the example machine of FIG. 1B. Display 350 provides information to a user, and in certain app clients 130 includes a touchscreen. Network interface 355 allows the app client 130 to communicate with controlled communication server 100 as well as with other clients 130, 135 via network 110. In various embodiments, network interface 355 is capable of communication via data networks and/or telecommunications networks (including mobile communication networks). It is noted that the modules described herein may be embodied as instructions stored in a storage device, e.g., 154, 166, and executable by a processor, e.g., 152, so that the processor, e.g., 152, is configured to perform the functions described.

Operating system 370 provides a local file management system and executes the various software modules such as client application 300, SMS application 375, and native notification module 380. Operating system 370 also displays information from applications executing on app client 130 to a user via display 350. Camera 360 may be used to capture images or video for upload.

Native notification modules 380 vary based on the app client, and facilitate delivery of notification messages to the app client user via a native device messaging system. A typical native notification module 380 includes a notification interface that enables client applications 300 and other sources to send notification messages to the app client for display to the user. Notifications may originate on app client 130 or on a server connected to app client 130 via network 110. SMS application 375 allows the app client user to compose, read, send, and receive SMS messages SMS application includes a user interface for composing and reading SMS messages, and an SMS interface for sending and receiving SMS messages via network 110.

Client application 300 can be a dedicated application or module that provides access to the services of controlled communication server 100, providing both user access to user content through a user interface, as well as programmatic access for other applications. App client 130 may also access controlled communication server 100 through browser 365. Client application 300 may take various forms, such as a stand-alone application, an application plug-in, or a browser extension. Client application 300 includes user interface module 305, message module 310, connection module 315, user content module 320, and local data store 325.

User interface module 305 generates an interface to the content accessed by client application 300, as variously illustrated herein, and is one means for performing this function. The generated interface is provided to the user by display 350. Client application 300 stores content accessed from a data store at controlled communication server 100 in local data store 325.

In various embodiments, connection module 315 communicates with various modules of controlled communication server 100 to enable a user to create and manage connections. A user initiates a connection request, including content sharing instructions, via a user interface element of app client 130. Connection module 315 handles the request and communicates with request module 210 or connection module 208 to create the connection. Connection module 315 may also access existing connections stored on controlled communication server 100 so that a user may view and modify existing connections using app client 130.

User content module 320 obtains and manages user content relating to a user's account. In various embodiments, a user can view and modify the user's own user content and content sharing instructions via the user interface on device 130. User content module 320 communicates with user content module 204 of the controlled communication server 100 to access and update user content and content sharing instructions. User content module 320 also communicates with user content module 320 or connection module 208 to access content items and content sharing instructions associated with a connected user. In some embodiments, user content module 320 is configured to communicate with SMS application 375 and other applications of app client 130. For example, if a connected user has shared a mobile phone number with a user, user content module 320 can communicate with SMS application 375 to open a window to compose an SMS message and automatically populate the recipient's phone number in the appropriate field.

In some embodiments, message module 310 is configured to allow a user of app client 130 to send, receive, compose, and read internal messages. Message module 310 communicates with internal message module 202 to provide internal messages to a user of app client 130 via the user interface.

### Example Appless Client

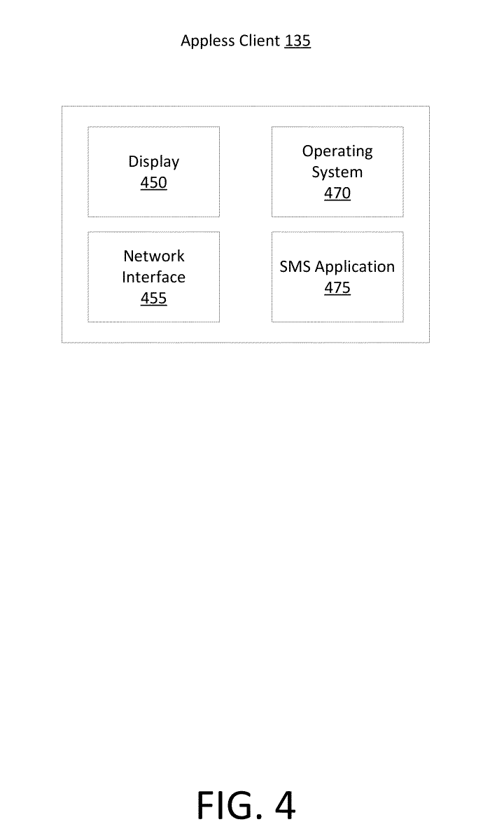

FIG. 4 is an example configuration of an appless client 135, according to one embodiment. Appless client 135 includes display 450, network interface 455, operating system 470, and SMS application 475. In various embodiments, appless client 135 may additionally include various components of the example machine of FIG. 1B. Display 450 provides information to a user, and in certain appless clients 135 includes a touchscreen. Network interface 455 allows the appless client 135 to communicate with controlled communication server 100 as well as with other clients 130, 135 via network 126. In various embodiments, network interface 455 is capable of communication via data networks and/or telecommunications networks (including mobile communication networks).

Operating system 470 provides a local file management system and executes the various software modules such as SMS application 475. Operating system 470 also displays information from applications executing on appless client 135 to a user via display 450. As an example of one communication channel, SMS application 475 allows the appless client user to compose, read, send, and receive SMS messages SMS application includes a user interface for composing and reading SMS messages, and an SMS interface for sending and receiving SMS messages via network 110.

### Example Connection Initiation Process

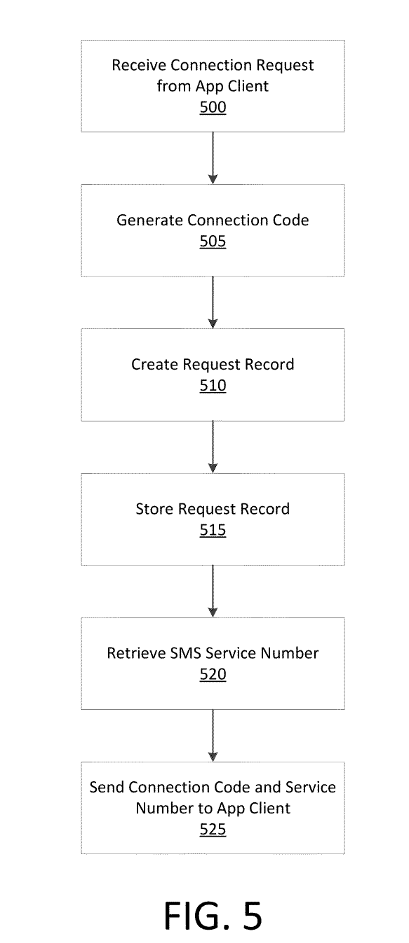

FIG. 5 illustrates an example process for initiating a connection between app user 140 of the app client 130 and an appless user 145 of the appless client 135 in a controlled communication server. The controlled communication server 100 receives 500 a connection request from an app client 130. The connection request may include a reference to one or more user content items that the user 140 of the app client 130 wishes to share with another user. In various embodiments, the connection request is received by request module 210. Request module 210 generates 505 a connection code responsive to the request. The connection code is a unique code associated with the two users seeking connection. The request module creates 510 a request record. The request record includes the generated connection code as well as the unique identifier of the app user 140 of the app client 130. The request record is stored 515 in request record data store 224. Request module 210 retrieves 520 a service number from service number data store 228. Request module 210 then sends 525 the connection code and the service number to the app client for display on the app client. The app user 140 of the app client 130 can share the connection code and service number to an appless user 145 of an appless client 135. Sharing may happen in person (e.g., visually or audibly), or via some other form of communication, as represented by the dashed line between users in FIG. 1A. For example, the appless user 145 may use SMS application 475 of appless client 135 to send the connection code to the service number.

### Example Communication Channel Creation Process

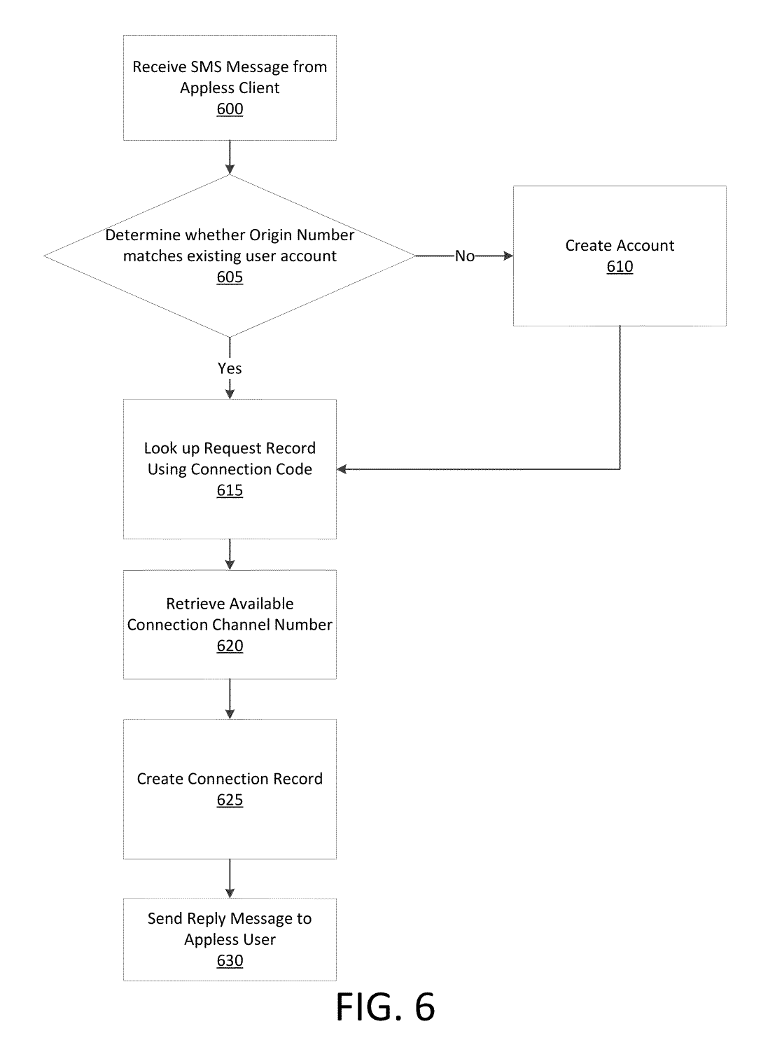

FIG. 6 illustrates an example process for creating a communication channel between users of information sharing control. In one embodiment, external message module 200 of controlled communication server 100 receives 600 an SMS message from an appless client 135. The SMS message includes the origin number (a 10-digit phone number or other SMS identifier), the destination number, and a previously-sent connection code as the SMS message content. Account module 212 determines 605 whether the origin number matches an existing user account stored in account data store 220. If the origin number does match an existing user account, the process proceeds to step 615 as indicated in FIG. 6. If the origin number does not match an existing user account, account module 212 creates 210 a new account record in account data store 220. The account record contains a newly-assigned unique user identifier as well as the origin number. Connection module 208 looks up 615 the request record associated with the connection code in request record data store 224. Connection module 208 retrieves 620 an available connection channel number from connection channel data store 230. An available connection channel number may be in use by other users, but it must not be in use by the appless user. In this way, a combination of the appless user's unique user identifier and the connection channel number is unique and may be specifically associated with a connection record associated with the appless user and the app user described above. Connection module 208 creates 625 the connection record in connection data store 226. The connection record includes the connection channel number, the user identifier of the user who initiated the request from the request record, and the user identifier of the appless user. External message module 200 sends a reply message to the appless user (via the origin number). The reply message may include shared user content of the requesting user.

### Example Message Routing

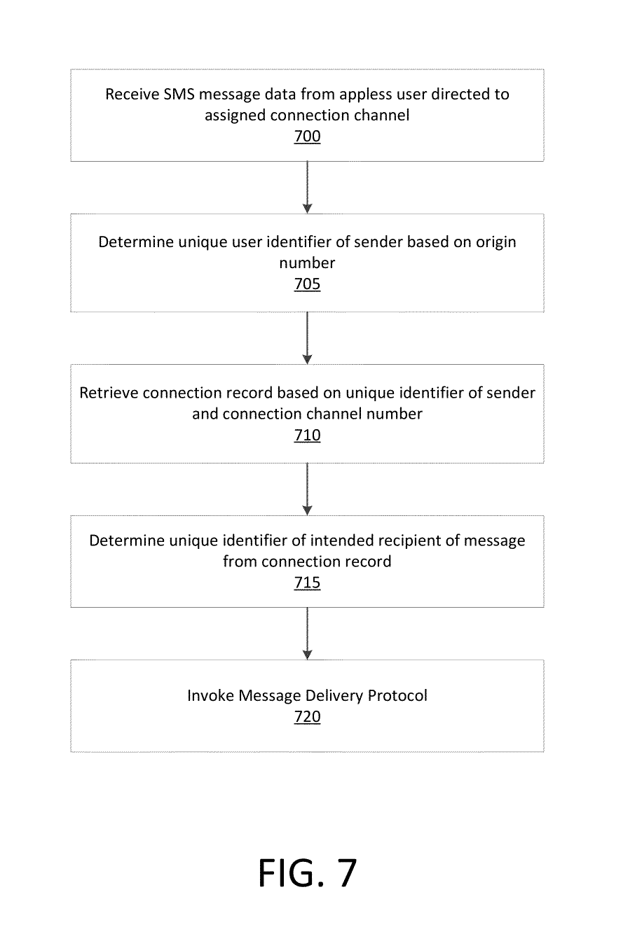

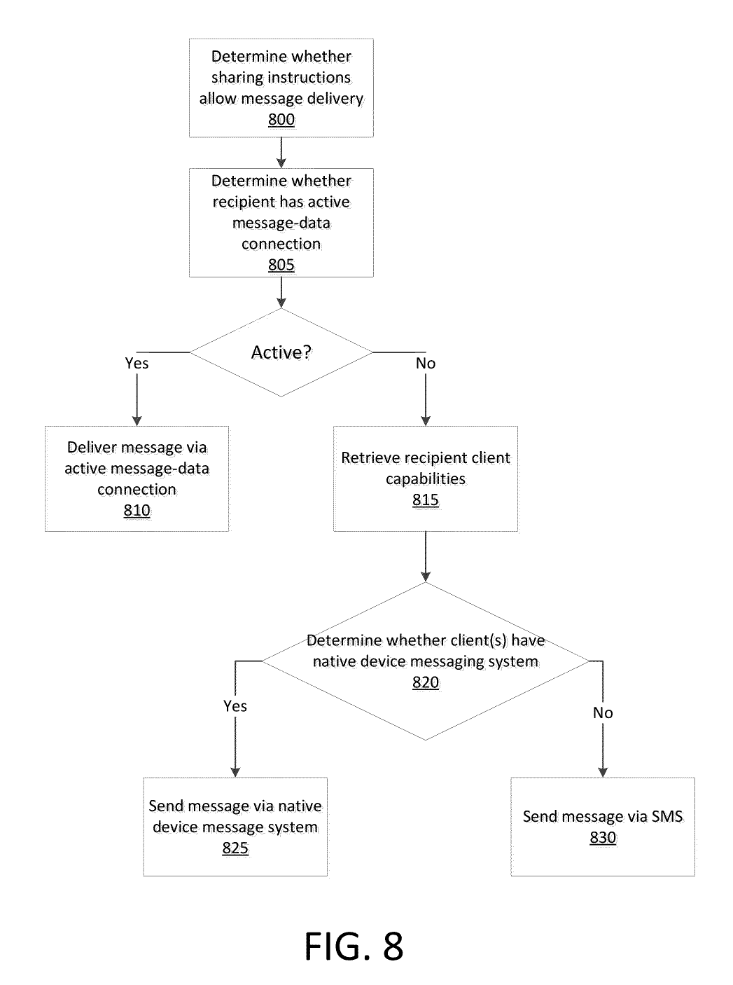

FIG. 7 illustrates an example process for routing messages with information sharing control. In various embodiments, external message module 200 receives 700 an SMS message from an appless user 135. The SMS message is sent to a connection channel number and has an associated origin number and a message. Connection module 208 determines 705 the user identifier of the sender of the message from the sender's account record in account data store 220. Connection module 208 retrieves 710, from connection data store 226, the connection record that is uniquely associated with the appless user and the connection channel number. From the connection record, connection module 208 determines 715 the unique user identifier of the intended recipient of the message. Connection module 208 invokes 720 the message delivery protocol, as described in FIG. 8.

FIG. 8 illustrates an example process for delivering messages to users of information sharing control. The process of FIG. 8 may be initiated as part of the process in FIG. 7 or it may be initiated in another situation in which a sending user sends a message to a receiving user. Connection module 208 determines 800, from the connection record, whether the content sharing instructions allow delivery of the message from the sending user to the receiving user. In one embodiment, if sharing instructions do not allow delivery, the sending user is notified. If sharing instructions do allow delivery, connection module 208 determines 805 whether the client of the recipient has an active message-data connection. If the client of the recipient has an active message-data connection, the message is delivered 810 by internal message module 202 via the active message-data connection. If the client of the recipient does not have an active message-data connection, connection module 208 retrieves 815 client characteristics of the receiving user in account data store 220. Specifically, connection module 208 determines 820 whether clients 130, 135 associated with the receiving user have a native device messaging system that is accessible by internal message module 202. If one or more clients 130, 135 associated with the receiving user have a native device messaging system that is accessible by internal message module 202, internal message module 202 sends 825 the message via the native device message system. If one or more clients 130, 135 associated with the receiving user have a native device messaging system that is accessible by internal message module 202, external message module 200 sends 830 the message via SMS.

### Example User Interfaces

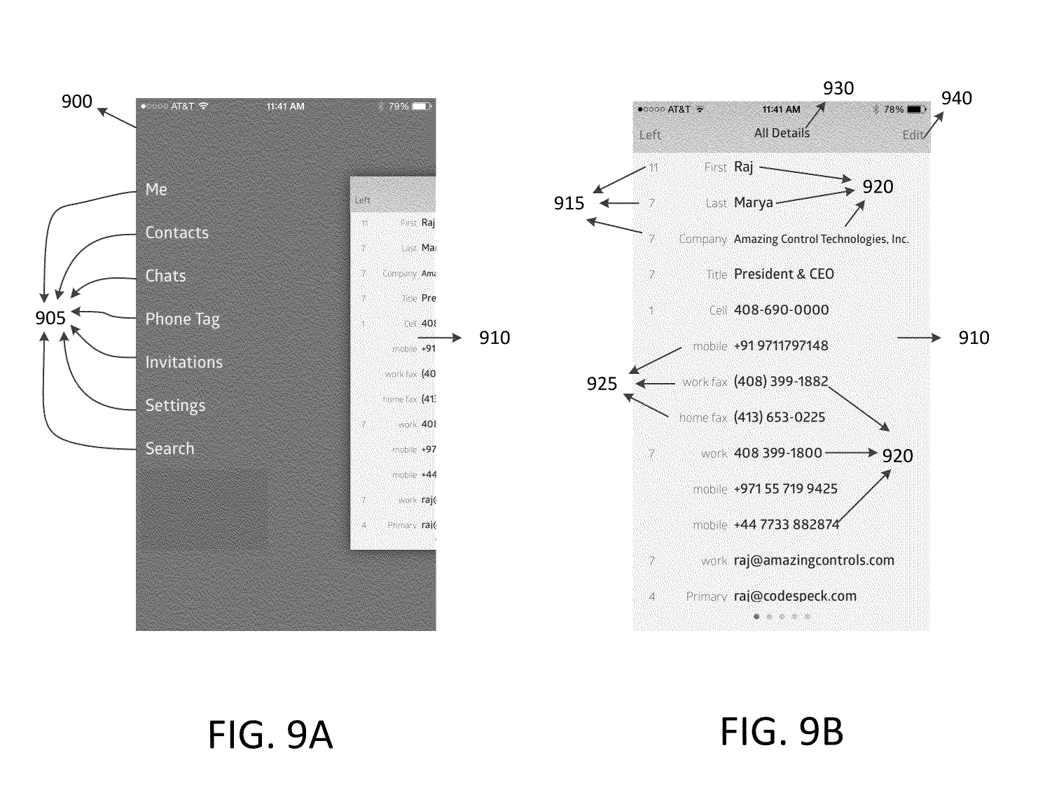

FIGS. 9-13 show example user interfaces for information sharing control. In some embodiments, the example user interfaces in FIGS. 9-13 are shown on display 350 of app client 130. User interface module 305 provides the user interface to operating system 370 for display. User interface module 305 also accepts and manages user inputs to the user interface. User inputs are made to various user interface elements via a touchscreen or another user input device, for example, a mouse, trackpad or keyboard.

FIG. 9A shows an example user interface of client application 300. Menu elements 905 allow a user to navigate to different features within client application 300. Screen 900 displaying the menu elements may be accessed at any time while a user is using client application 300. In this example, screen 900 was accessed while a user was viewing screen 910, which displays the user's content items. As shown in FIG. 9A, in various embodiments, a portion of the screen from which screen 900 was accessed may be displayed such that when a user interacts with that portion, the user returns to the screen from which screen 900 was accessed. In this example, touching the portion of screen 910 displays screen 910. In this example, selecting the “Me” menu element also displays screen 910.

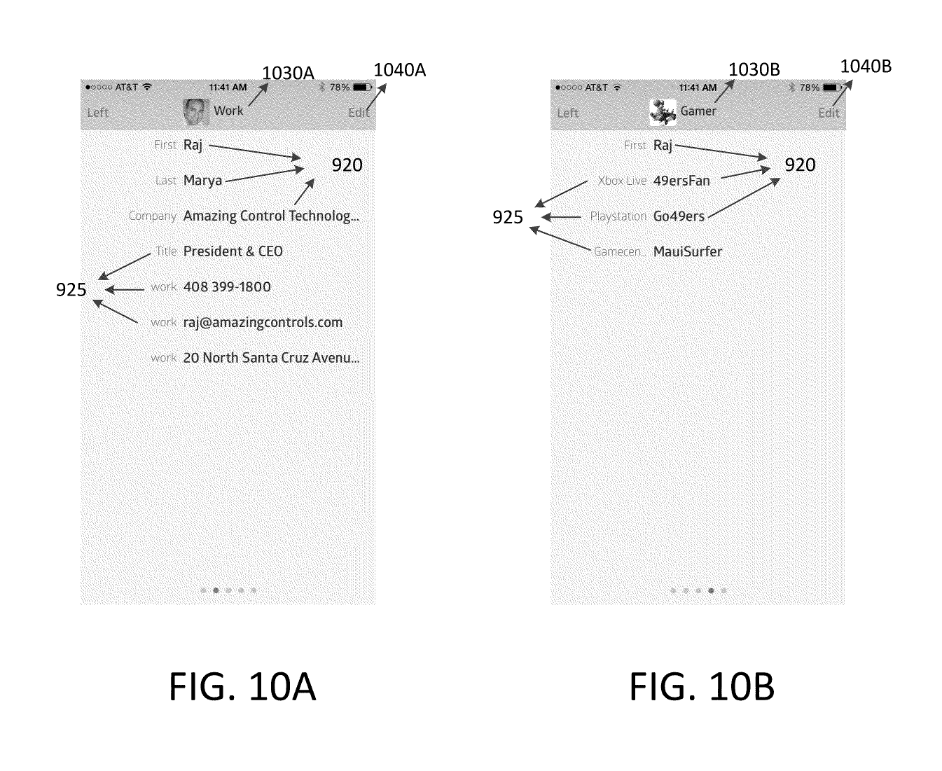

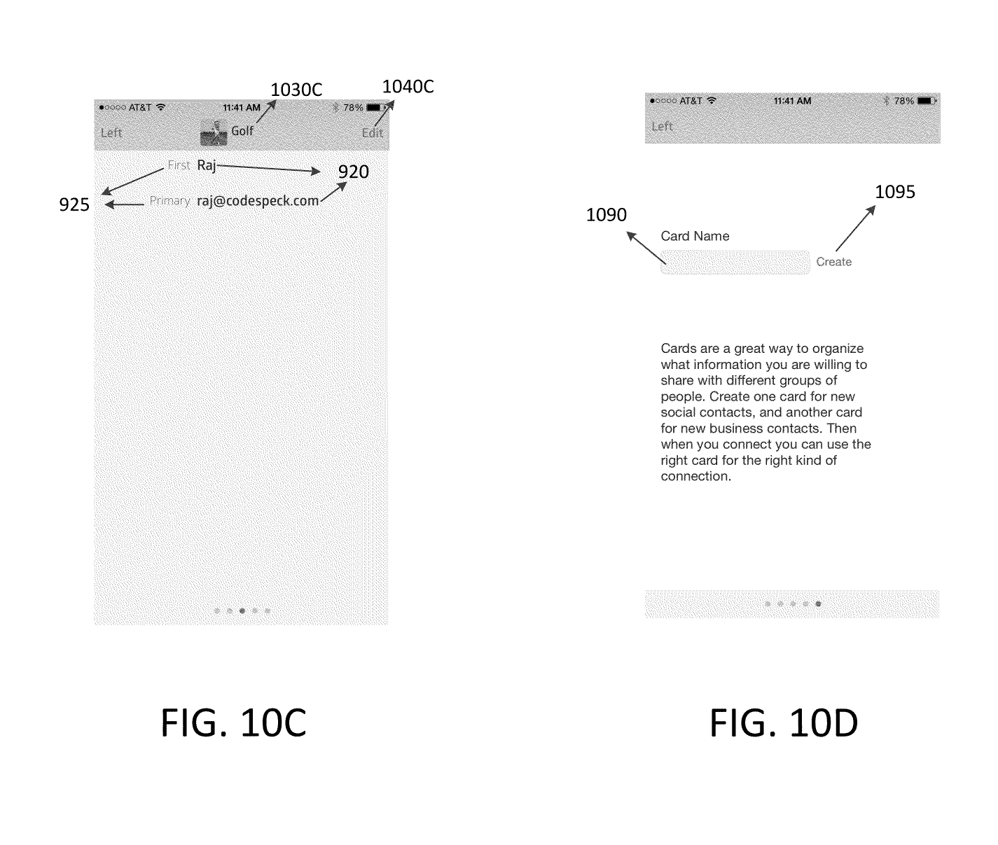

As shown in FIG. 9B, screen 910 displays a list of the user content items of the user of the client application 300. Title element 930 indicates to the user which content item group is being displayed. In this example, all of the user's content items are displayed. The user may navigate to other pages that display other content groups by, for example, using touchscreen gestures. Examples of user interfaces displaying other content groups are shown in FIGS. 10A-10C. Edit element 940 allows the user to make modifications to the content items. User content module 320 communicates with controlled communication server 100 to update user content that is stored in user content data store 222. User content items 920 are retrieved from user content data store 222 for display on app client 130. Content item identifiers 925 are stored in user content data store 222 as well and describe the nature of a specific content item. Example content item identifiers include “First” for a user's first name, or “mobile” for a user's mobile device phone number. Share count elements 915 indicate, for each user content item 920, how many other users have been given access to the user content item 920.

FIGS. 10A-C show an example user interfaces displaying different content groups. In the example in FIG. 10A, title element 1030A indicates that the content group is titled “Work”. Similarly, title element 1030B in FIG. 10B indicates that the content group is titled “Gamer”, and title element 1030C in FIG. 10C indicates that the content group is titled “Golf”. Edit elements 1040 allow the user to make modifications to the content items as well as to view and edit the list of users that may access the content items in the content group. For the “Work” content group, for example, a user may add work contacts to the list of users that may access the content items. For the “Gamer” content group, as another example, a user may add contact with which the user plays video games to the list of users that may access the content items. In this manner, a user may share different information with different social and professional groups to which the user belongs without having to share any other details electronically from the same electronic record. FIG. 10D shows an example user interface for creating a new content group. A user may enter the name of the content group in name input element 1090 and create the content group using create element 1095.

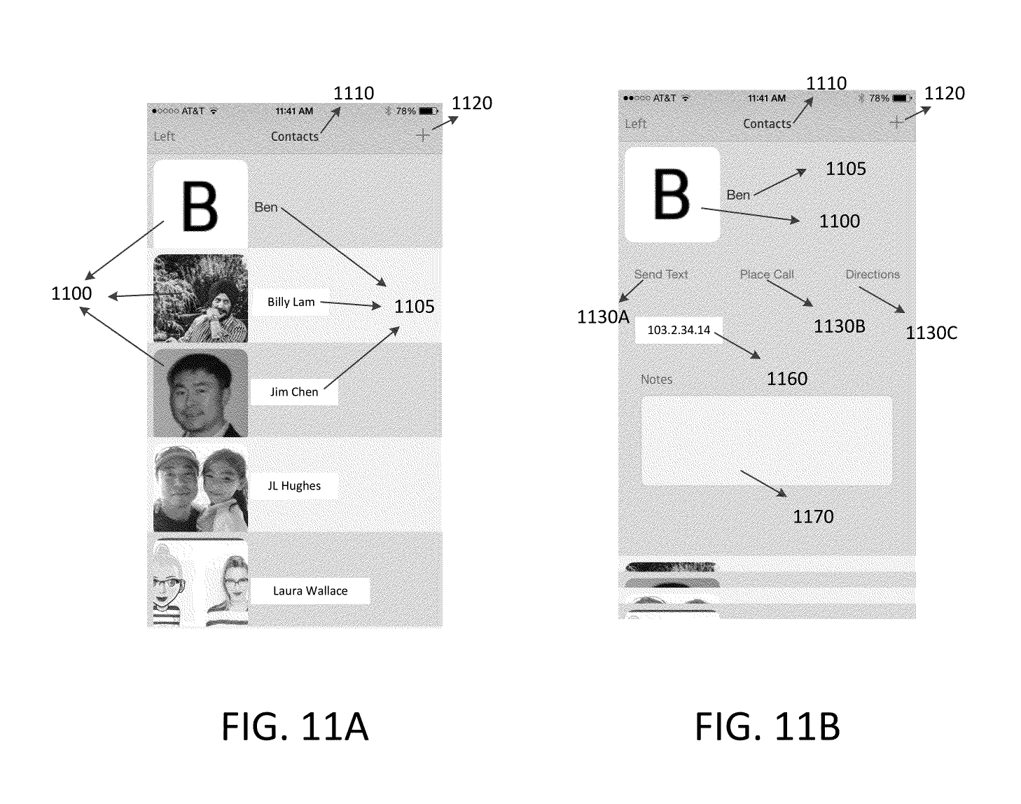

FIGS. 11A-11B show example user interfaces for viewing and accessing user content of other users. FIG. 11A shows a list of other users for which the user of client application 300 has content item access. For purposes of illustration, the users are herein referred to as “contacts.” The screen of FIG. 11A may be accessed, for example, by tapping the “Contacts” element of FIG. 9A. Title element 1110 indicates that the user is accessing user content of contacts. For each of a user's contacts, the user is granted access to different content items. The list of a user's contacts in the example user interface includes a picture 1100 associated with the contact as well as a name 1105 associated with the contact. The user may get more information about a contact by tapping the area associated with the picture 1100 or the name 1105. A user may add a new contact by tapping add contact element 1120.

FIG. 11B shows an example user interface when the user taps the area associated with the picture 1100 or the name 1105 to get more information about a contact. Picture 1100 and name 1105 are displayed. Additionally, the contact's user identifier is displayed by user identifier element 1160. The user may enter notes in input element 1170. Further, various communication methods and other information is available through interaction elements 1130. In this example, interaction element 1130A gives a user the ability to send an SMS message to Ben. Of note, interaction element does not display the number at which Ben will receive the SMS message. Controlled communication server 100 may deliver an SMS message to Ben without the user ever knowing the number at which Ben will receive the SMS message. As such, Ben can decide he does not want to receive SMS messages from the user any longer and revoke the user's access to Ben's SMS information, and the user will no longer be able to communicate with Ben in this manner. Similarly, interaction element 1130B allows the user to place a call to Ben. Ben's phone number may similarly be withheld from the user allowing Ben to suspend phone communications with the user at any time.

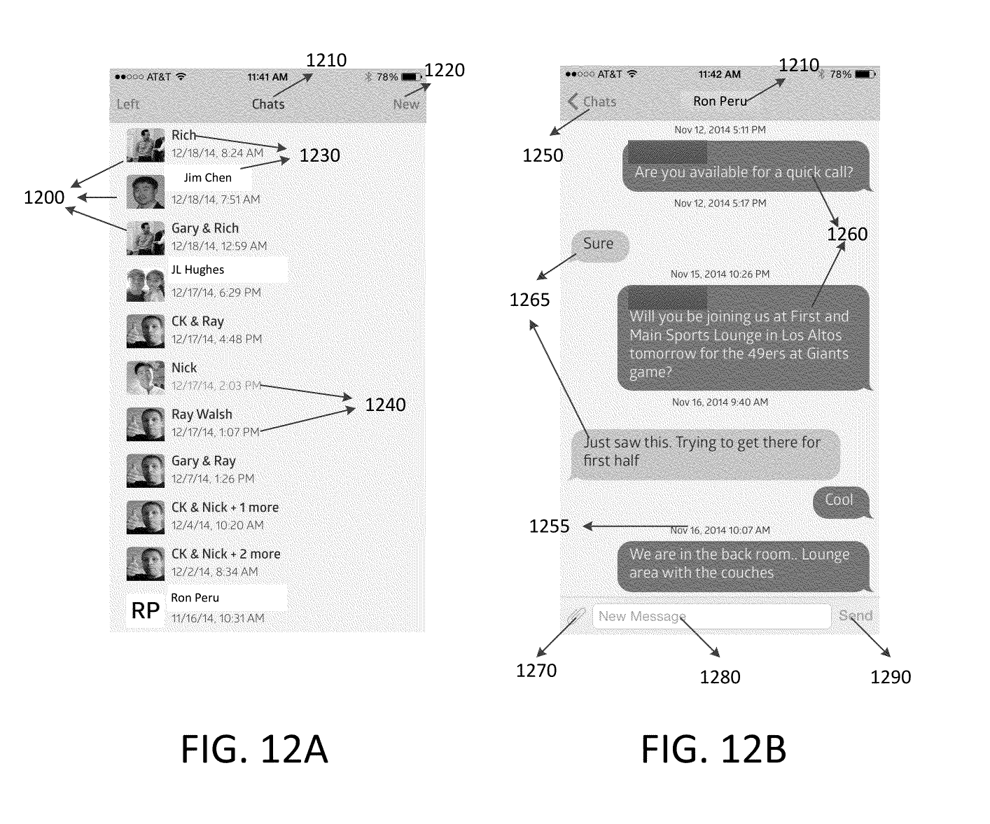

FIGS. 12A-12B show example user interfaces for messaging between connected users. Messaging may occur between two or more users of the system. In various embodiments, messaging between users may be controlled by message module 310. Message data may be stored on controlled communication server 100 or in local data store 325. FIG. 12A shows an example user interface for viewing messaging sessions in which the user has participated. The screen of FIG. 12A may be accessed, for example, by tapping the “Chat” element of FIG. 9A. Title element 1210 indicates that the user is viewing messaging sessions. Contact name elements 1230 and contact picture elements 1200 correspond to the participants in the messaging session besides the user. For the other participants, chat may occur within client application 300, but it may also occur outside of the system altogether such as via SMS message. Date and time elements 1240 display the date and time of the most recent message in the session. New message element 1220 allows a user to initiate a new messaging session. The user may tap the area associated with elements 1200, 1230, and 1240 to access the messaging session.

FIG. 12B shows an example user interface for a messaging session. Title element 1210 shows the user the other participant(s) in the messaging session. Return element 1250 allows the user to return to the screen show in FIG. 12A. Message elements 1260 display the messages that the user has sent during the messaging session. Message elements 1265 display messages received from other participants during the messaging session. Date and time information elements 1255 display the date and time associated with a message. Message text element 1280 allows a user to input text for a new message. Attachment element 1270 allows a user to input other file types to send with a message. These include documents, pictures, and other electronic files. Send element 1290 allows a user to send the composed message and/or attached files to the other participants in the session.

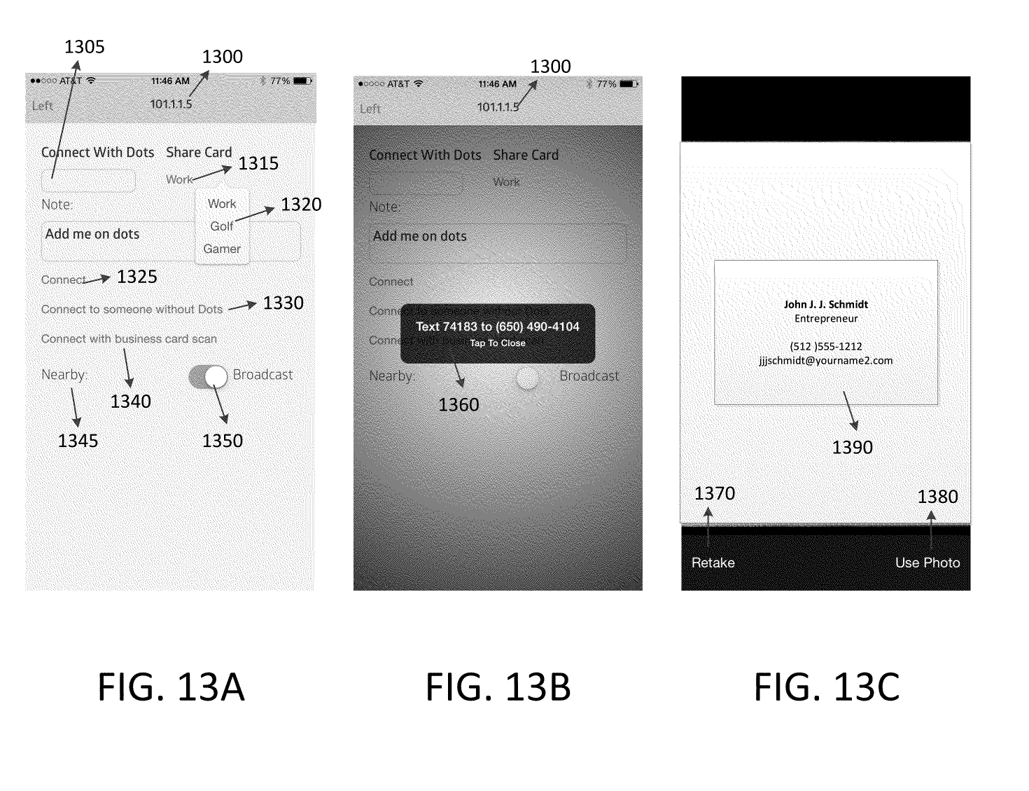

FIGS. 13A-13C illustrate example user interfaces for initiating a connection between users of the information sharing control. In some embodiments, FIG. 13A includes user interface elements associated with various methods for initiating a connection. Title element 1300 displays the user identifier of the user of the client application 300. The user may share this identifier with other users of the information sharing control to initiate a connection. User ID connection element 1305 allows the user to enter the user identifier of the receiving user with which the user would like to connect. Group element 1315 allows the user to select which content group to give the receiving user access to. Group element 1315, if clicked or tapped, may display menu 1320 with options for which content group to select. The user may enter an optional note, and click or tap connect element 1325 to initiate a connection. The receiving user receives a message containing the note and one or more content items and may choose whether to accept or deny the connection request. Alternatively, the user may imitate a connection by enabling broadcast toggle 1350 to detect whether other users are also broadcasting nearby. Alternatively, the user may tap or click appless connect element 1330. This causes client application 300 to display the example user interface in FIG. 13B, which contains request message 1360. Request message 1360 includes the connection code and the service number that is sent to the app client for display in step 525 of FIG. 5. As another example, the user may select business card scan element 1340 to invoke the example user interface in FIG. 13C. Using camera 360 of the client, the user may take a picture of a business card or other contact information. Connection module 208 uses optical character recognition to find or create a user account associated with the recognized contact information.

### Example Connection Termination Process

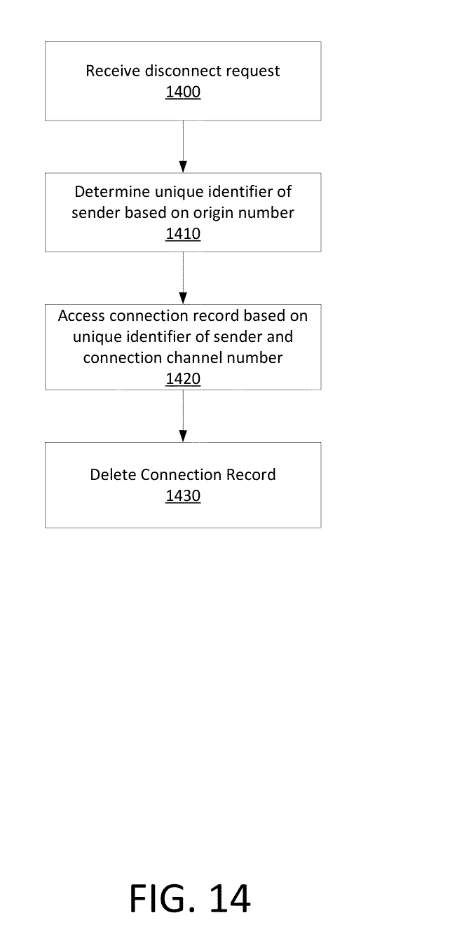

FIG. 14 illustrates an example process for terminating a connection between users of information sharing control. In one embodiment, request module 210 receives 1400 a disconnect request from a user of information sharing control. The disconnect request may be sent via a user interface element. In another embodiment, the disconnect request is sent via a message service or other communication service (e.g. SMS message service). In still another embodiment, the disconnect request is sent automatically upon the happening of an event (i.e. at the expiration of a time period). Connection module 208 determines 1410 the user identifier of the sender of the message from the sender's account record in account data store 220. Connection module 208 accesses 1420 the connection record in connection data store 226. Connection module 208 deletes 1430 the connection record from connection data store 226. Thus, the users associated with the connection record are no longer able to communicate via information sharing control. Because personal contact information (e.g., phone numbers, addresses, etc.) is not shared, users are unable to contact one another once a communication is terminated.

### Additional Considerations

The information sharing control as disclosed provides benefits and advantages that include allowing participants in electronic device communication to control information that is shared during communication. It further allows those participants to control future communication by allowing continuous changes by participants, including changes to whether any piece of information is shared and alterations to the information itself.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1-4. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein, e.g., with respect to FIGS. 5-13C, may be performed, at least partially, by one or more processors, e.g., processor 152, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine but possibly deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other but still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for controlling the information that is shared during electronic communication through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer-implemented method for establishing a connection for controlled communication comprising:
receiving, by a computer, a request from a first user, the request comprising a user identifier of the first user and content handling instructions, the content handling instructions corresponding to a second user;
generating a request record responsive to the request, the request record comprising the user identifier of the first user, the content handling instructions, and a connection identifier;
receiving a connection message comprising the connection identifier from a device of the second user, the device of the second user having an origin identifier;
generating a connection record, the connection record comprising the origin identifier, the user identifier of the first user, the content handling instructions, and a channel identifier, the channel identifier associated with an electronic communication channel;
transmitting, via the electronic communication channel, a confirmation message to the device of the second user comprising shared contact information of the first user;
determining, from the connection record, the identifier of the first user and the content handling instructions in response to receiving, via the electronic communication channel, a communication message from the device of the second user; and
executing, by the computer, one or more of the content handling instructions.

2. The method of claim 1, wherein the content handling instructions are prescribed by the first user.

3. The method of claim 1, wherein the user identifier of the first user is uniquely assigned to the first user from a plurality of available user identifiers.

4. The method of claim 1, wherein the shared contact information comprises one or more of a plurality of contact information items associated with the first user.

5. The method of claim 4, wherein the content handling instructions specify which, if any, of the plurality of contact information items, is included in the set of contact information.

6. The method of claim 4, wherein each item of the plurality of contact information items associated with the first user is stored in a contact information database and is associated with the user identifier of the first user.

7. The method of claim 3, further comprising:
responsive to receiving the connection message, assigning a second user identifier to the second user from the plurality of available user identifiers.

8. The method of claim 1, further comprising:
determining, from an alternative connection record, the identifier of the first user and alternative content handling instructions, in response to receiving, via the communication channel, a communication message from the device of a third user;
wherein the alternative content handling instructions correspond to the third user;
wherein the alternative content handling instructions are different from the content handling instructions corresponding to the second user; and
executing, by the computer, one or more of the alternative content handling instructions.

9. The method of claim 1, further comprising:
transmitting, via the communication channel, an alternative communication message to the device of a third user comprising alternative shared contact information of the first user;
wherein the alternative shared contact information comprises one or more of a plurality of contact information items associated with the first user; and
wherein the alternative shared contact information is different from the shared contact information.

10. A system for establishing a connection for controlled communication comprising:
a processor configured to execute instructions;
a non-transitory, non-volatile storage medium containing instructions, which when executed by the processor cause the processor to:
receive a request from a first user, the request comprising a user identifier of the first user and content handling instructions, the content handling instructions corresponding to a second user;
generate a request record responsive to the request, the request record comprising the user identifier of the first user, the content handling instructions, and a connection identifier;
receive a connection message comprising the connection identifier from a device of the second user, the device of the second user having an origin identifier;
generate a connection record, the connection record comprising the origin identifier, the user identifier of the first user, the content handling instructions, and a channel identifier, the channel identifier associated with an electronic communication channel;
transmit, via the electronic communication channel, a confirmation message to the device of the second user comprising shared contact information of the first user;
determine, from the connection record, the identifier of the first user and the content handling instructions in response to receiving, via the electronic communication channel, a communication message from the device of the second user; and
execute one or more of the content handling instructions.

11. The system of claim 10, wherein the content handling instructions are prescribed by the first user.

12. The system of claim 10, wherein the user identifier of the first user is uniquely assigned to the first user from a plurality of available user identifiers.

13. The system of claim 10, wherein the shared contact information comprises one or more of a plurality of contact information items associated with the first user.

14. The system of claim 10, wherein the content handling instructions specify which, if any, of the plurality of contact information items, is included in the set of contact information.

15. The system of claim 13, wherein each item of the plurality of contact information items associated with the first user is stored in a contact information database and is associated with the user identifier of the first user.

16. The system of claim 12, further comprising:
responsive to receiving the connection message, assigning a second user identifier to the second user from the plurality of available user identifiers.

17. The system of claim 10, further comprising:
determining, from an alternative connection record, the identifier of the first user and alternative content handling instructions, in response to receiving, via the communication channel, a communication message from the device of a third user;
wherein the alternative content handling instructions correspond to the third user;
wherein the alternative content handling instructions are different from the content handling instructions corresponding to the second user; and
executing, by the computer, one or more of the alternative content handling instructions.

18. The system of claim 10, further comprising:
transmitting, via the communication channel, an alternative communication message to the device of a third user comprising alternative shared contact information of the first user;
wherein the alternative shared contact information comprises one or more of a plurality of contact information items associated with the first user; and
wherein the alternative shared contact information is different from the shared contact information.

19. A computer readable medium configured to store instructions, the instructions when executed by a processor cause the processor to:
receive a request from a first user, the request comprising a user identifier of the first user and content handling instructions, the content handling instructions corresponding to a second user;
generate a request record responsive to the request, the request record comprising the user identifier of the first user, the content handling instructions, and a connection identifier;
receive a connection message comprising the connection identifier from a device of the second user, the device of the second user having an origin identifier;
generate a connection record, the connection record comprising the origin identifier, the user identifier of the first user, the content handling instructions, and a channel identifier, the channel identifier associated with an electronic communication channel;
transmit, via the electronic communication channel, a confirmation message to the device of the second user comprising shared contact information of the first user;
determine, from the connection record, the identifier of the first user and the content handling instructions in response to receiving, via the electronic communication channel, a communication message from the device of the second user; and
execute one or more of the content handling instructions.

20. The computer readable medium of claim 19, wherein the content handling instructions are proscribed by the first user.

21. The computer readable medium of claim 19, wherein the user identifier of the first user is uniquely assigned to the first user from a plurality of available user identifiers.

22. The computer readable medium of claim 19, wherein the shared contact information comprises one or more of a plurality of contact information items associated with the first user.

23. The computer readable medium of claim 22, wherein the content handling instructions specify which, if any, of the plurality of contact information items, is included in the set of contact information.

24. The computer readable medium of claim 22, wherein each item of the plurality of contact information items associated with the first user is stored in a contact information database and is associated with the user identifier of the first user.

25. The computer readable medium of claim 21, further comprising instructions that cause the processor to:
responsive to receiving the connection message, assign a second user identifier to the second user from the plurality of available user identifiers.

26. The method of claim 19, further comprising instructions that cause the processor to:
determine, from an alternative connection record, the identifier of the first user and alternative content handling instructions, in response to receiving, via the communication channel, a communication message from the device of a third user;
wherein the alternative content handling instructions correspond to the third user;
wherein the alternative content handling instructions are different from the content handling instructions corresponding to the second user; and
execute, by the computer, one or more of the alternative content handling instructions.

27. The method of claim 19, further comprising instructions that cause the processor to:
transmit, via the communication channel, an alternative communication message to the device of a third user comprising alternative shared contact information of the first user;
wherein the alternative shared contact information comprises one or more of a plurality of contact information items associated with the first user; and
wherein the alternative shared contact information is different from the shared contact information.
